(19) United States
(12) Patent Application Publication
(10) Pub. No.: US 2024/0204373 A1
(43) Pub. Date: Jun. 20, 2024

(54) A CYLINDRICAL SECONDARY CELL WITH A TERMINAL SURFACE WITH DIFFERENT ROUGHNESS

(71) Applicant: Northvolt AB, Stockholm (SE)

(72) Inventors: Brendan Sexton, Västerås (SE); Kenya Shatani, Stockholm (SE); Tetsuya Makino, Solna (SE); Amelie Lundius, Stockholm (SE)

(21) Appl. No.: 18/566,838

(22) PCT Filed: Jun. 1, 2022
(86) PCT No.: PCT/EP2022/064856

§ 371 Date: Dec. 4, 2023

(30) Foreign Application Priority Data
Jun. 4, 2021 (SE) 2150717-3

(51) Int. Cl. H01M 50/559; H01M 50/107; H01M 50/179

(52) U.S. Cl. CPC H01M 50/559; H01M 50/107; H01M 50/179

(57) ABSTRACT

The disclosure shows a cylindrical secondary cell (1) comprising a cylindrical can (2) comprising an end side (2a), and a terminal (3), arranged at the can end side (2a). The terminal (3) comprises a terminal surface (4) for connecting external electrical interconnects to the cylindrical secondary cell (1). The terminal surface (4) comprises a first part (4a) formed by a centre region of the terminal surface and being at least partly surrounded by a second part (4b) of the terminal surface, wherein a first surface roughness of the first part (4a) exceeds a second surface roughness of the second part (4b).

### TECHNICAL FIELD

The present disclosure relates to a cylindrical secondary cell.

### BACKGROUND

The transition from fossil fuels towards renewable energy has gained considerable momentum. One of the most important contributing factors is the development of better and cheaper rechargeable batteries. Currently, lithium-ion batteries are becoming increasingly popular. They represent a type of rechargeable battery in which lithium ions move from the negative electrode to the positive electrode during discharge and back when charging.

As the demand for rechargeable batteries increases, focus is being placed on improving them. There are many ways to improve batteries; mechanical changes to, for example, improve safety or production complexity, and chemical changes to, for example, improve energy density or power of the battery cell.

A rechargeable battery, or, in other words, a secondary battery, comprises one or more secondary cells.

### SUMMARY

In view of the above, it is an aim of the disclosure to provide an improved cylindrical secondary cell for rechargeable batteries.

This aim is achieved by a device as defined in claim 1.

The disclosure provides a cylindrical secondary cell comprising a cylindrical can comprising an end side, and a terminal, arranged at the can end side. The terminal comprises a terminal surface for connecting external electrical interconnects to the cylindrical secondary cell. The terminal surface comprises a first part surrounded by a second part. A first surface roughness of the first part exceeds a second surface roughness of the second part by more than a predetermined amount. In other words, on the terminal surface there are two parts which have different surface roughness. The first part has a rougher surface than the second part. Thus, the terminal surface has a part with a rough surface surrounded by a part with a less rough surface. With this, two different surfaces are formed, one smoother and one rougher.

When having different roughness, different parts of the terminal surface are good for attaching to different external connectors. For example, the less rough second part can be used to laser weld an external connector and the rougher first part may be used to wire bond an external connector. When laser welding, it is beneficial to have a smooth surface to minimize the cabs between the materials to be welded together. For wire bonding, it is beneficial to have a rough surface to increase the bond strength. Due to the roughness of the surface, more material is engaged in the wire bonding, resulting in a larger overall bonding surface, which gives an increased mechanical strength of the bond.

In other words, having a terminal surface with two different areas of different roughness makes the terminal surface suitable for using different methods for connecting external electrical interconnects.

Another advantage with having a rougher part of the surface, is that the surface can be used to hold the cylindrical secondary cell in place in an assembly process of the cell or other handling process.

According to some aspects, the predetermined amount is more than 25 μm.

According to some aspects, the first part of the terminal surface is knurled. There are many ways to make a surface rougher, and one of them is to press a knurled tool against it so that a corresponding knurled pattern is formed on the terminal surface.

According to some aspects, the second surface roughness is less than 40 μm. In other words, the second part of the terminal surface is substantially smooth and flat.

According to some aspects, the terminal surface is circular, and the first part is arranged at the centre of the circular terminal surface. A common shape of the terminal surface of a cylindrical secondary cell is circular. If the first part is arranged in the centre of the circular shape, the terminal surface can be made to be rotationally symmetric over the whole surface. It can be beneficial to have a terminal surface that is symmetrical because then there is no need to turn the cell in a specific direction when attaching an external connector to it. The terminal surface may also be designed to have other shapes than circular, and the first part is then, preferably, arranged in the centre of that shape so that there is room to attach external connectors around the first part or on the first part.

The first part may have a shape corresponding to the terminal surface shape, but it may also have other shapes.

According to some aspects, the area of the first part is between 3% and 20% of the total area of the terminal surface, preferably between 6% and 15% of the total area of the terminal surface. The first part is large enough for connecting an external interconnection.

According to some aspects, the can end side is a second terminal of opposite polarity than the terminal and the cylindrical secondary cell comprises an isolating part between the can end side and the terminal. In this case, both the positive and the negative terminal is arranged on the same side of the can. Thus, both terminals can be connected to external interconnects on the same side. This makes it possible to only make connections on one side of the cell.

### BRIEF SUMMARY OF THE DRAWINGS

Different aspects are now described, by way of example, with reference to the accompanying drawings, in which:

FIG. 1 shows an example of a cylindrical secondary cell.

FIG. 2 shows an example of a cylindrical secondary cell from above with at least one terminal.

FIG. 3-8 shows examples of a terminal surface with different shapes of the first part and the second part.

### DETAILED DESCRIPTION

The disclosure is not limited to the embodiments disclosed but may be varied and modified within the scope of the claims. Aspects of the disclosure will now be described with reference to the accompanying drawings. The same reference numbers are used throughout the figures.

The terminology used herein is for the purpose of describing particular aspects of the disclosure only and is not intended to limit the invention. The singular forms “a”, “an” and “the” are intended to include plural forms as well, unless the context clearly indicates otherwise.

With the term “terminal” is meant a part of a secondary cell which is to be connected, i.e. enables connection, to an external load, via external electrical interconnects.

Alternative terms for the term “can” are “case” and “housing case”.

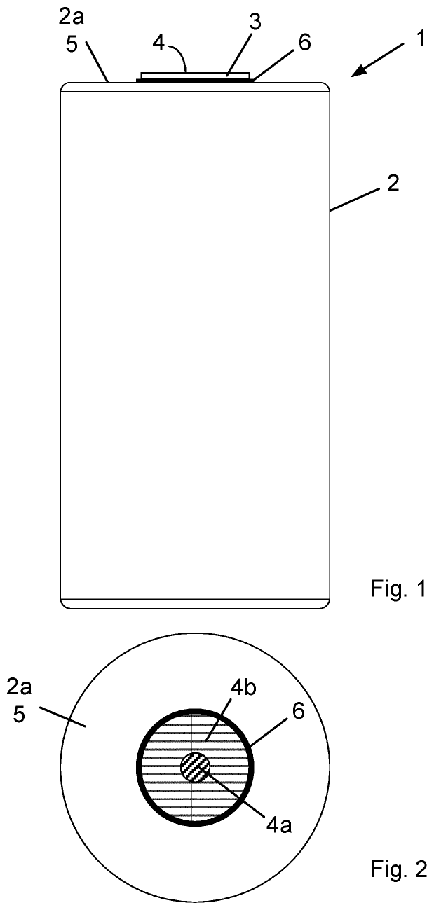

FIG. 1 shows an example of a cylindrical secondary cell 1. The cylindrical secondary cell 1 comprises a can 2 and a terminal 3 on top. The cylindrical secondary cell 1 can be a tabless cell or a cell with tabs and can contain different chemistries, for example for electrodes, separator and electrolyte. For the content described herein, the can 2 and the terminal 3 are the relevant parts and since the inside of the can 2, with its content, is not relevant, it is not discussed here. The inside of a cylindrical secondary cell 1 can be made in many different ways which are known to a skilled person. Therefore, the inside of the cylindrical secondary cell 1 is not disclosed here.

The cylindrical secondary cell 1 comprises a cylindrical can 2 comprising an end side, and a terminal 3, arranged at the can end side 2a. In FIG. 1, the can end side 2a is the top part of the can 2 and the terminal 3 is seen on top of the can end side 2a.

The terminal 3 comprises a terminal surface 4 for connecting external electrical interconnects to the cylindrical secondary cell 1. In FIG. 2, the can end side 2a is shown from above. Here, the terminal surface 4 can be seen in the middle of the can end side 2a. The black ring around the terminal surface 4 is an isolating part 6, electrically isolating the terminal 3 from the can 2. The isolating part 6 is used when the can end side 2a is also used as a second terminal 5, which is an alternative described further below. The isolating part 6 also improves the sealing of the cylindrical secondary cell so that electrolyte does not leak out of it.

The terminal surface 4 comprises a first part 4a surrounded by a second part 4b. In other words, the terminal surface 4 has two parts, one surrounding the other.

A first surface roughness of the first part 4a exceeds a second surface roughness of the second part 4b by more than a predetermined amount. In other words, on the terminal surface 4 there are two parts which have different surface roughness. The first part 4a has a rougher surface than the second part 4b. Thus, the terminal surface 4 has a part with a rough surface surrounded by a part with a less rough surface. With this, two different surfaces are formed, one smoother and one rougher; the rougher being surrounded by the smoother.

When having different roughness, different parts of the terminal surface 4 are good for attaching to different external connectors. For example, the less rough second part 4b can be used to laser weld an external connector and the rougher first part 4a may be used to wire bond an external connector. When laser welding, it is beneficial to have a smooth surface to minimize the cabs between the materials to be welded together. For wire bonding, it is beneficial to have a rough surface to increase the bond strength. Due to the roughness of the surface, more material is engaged in the wire bonding, resulting in a larger overall bonding surface, which gives an increased mechanical strength of the bond.

The smooth surface of the second part 4b can be used for busbar welding with laser and the rough surface of the first part 4a can be used for voltage sensor welding with wire-bonding.

Thus, having a terminal surface 4 with two different areas of different roughness makes the terminal surface 4 suitable for using different methods for connecting external electrical interconnects. Thereby, the cylindrical secondary cell 1 is arranged to connect external electrical interconnections of different types at different places on the terminal surface 4.

Wire bonding is commonly used in battery system assemblies to electrically connect the battery cells in series or in parallel. This is done by either connecting the battery cell terminals to collector plates or connecting the cells directly to each other. The process is executed by feeding and ultrasonically welding wire to the designated source surface after which the bond head is moved to the designated destination surface while feeding wire. The ultrasonic welding operation is then repeated, and the wire is cut.

During the welding operation the wire deformation is monitored, and weld parameters are adjusted to reach the specified weld characteristics. One of the critical quality characteristics of the bond is the mechanical shear strength, which is closely related to the penetration of the wire material into the base material.

Laser beam welding (LBW) has a wide range of applications. In the battery systems manufacturing laser welding can be used for electrically connect battery cells into systems. Commonly, a copper or aluminium busbar is welded to a battery cell terminal using a laser system delivering a highly intensive laser beam focused at the surface of the top sheet. The beam penetrates through the top bus bar material and into the terminal to form a weld. LBW generates low heat input due to the high energy density in the laser which results in a high-speed process.

Critical characteristics for LBW is the material characteristics of the top sheet and bottom sheet as well as the mating of the top and bottom sheet. A small gap between the sheets can cause lower penetration and occasionally an interrupted weld seam, which in turn can lead to low mechanical strength and/or increased electrical resistance between the parts.

The surface roughness is measured by taking the average value of the deviations in the direction of the normal vector of the terminal surface 4 from its ideal form. It's ideal form thus meaning an entirely flat surface without deviations. In other words, the surface roughness is the mean (or average) surface roughness Rz, wherein Rz is maximum peak to valley height of the profile, within a single sampling length. The surface roughness being measured according to ISO 4287-1997.

The predetermined amount is, for example, 25 μm. In other words, the first part 4a deviates at least 25 μm more from the ideal form of the terminal surface 4 than the second part 4b. The predetermined amount may also be, for example 50 μm, 100 μm, 150 μm or 200 μm.

The first part 4a of the terminal surface 4 is for example knurled. There are many ways to make a surface rougher, and one of them is to press a knurled tool against it so that a corresponding knurled pattern is formed on the terminal surface 4. A tool with an irregular surface roughness can of course also be used to press against the terminal surface 4 to produce a corresponding pattern on the first part 4a.

The second surface roughness is less than 40 μm. In other words, the second part 4b of the terminal surface 4 has little surface roughness and is substantially flat. The second surface roughness may also, for example, be less than 25 μm, or less than 20 μm.

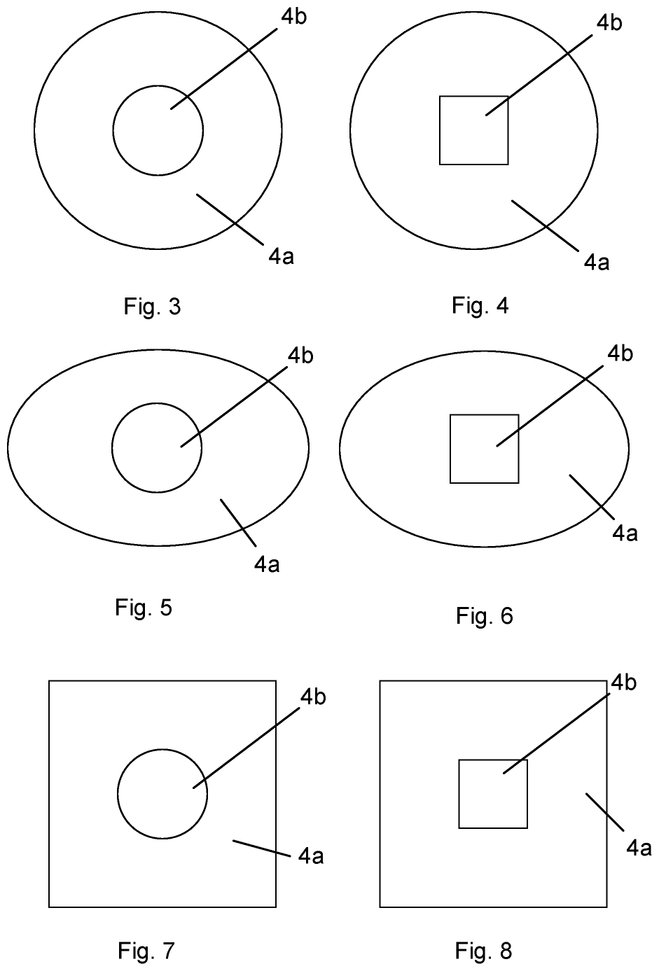

FIGS. 3-8 shows different alternatives of the terminal surface 4 with different shapes of the first part 4a and the second part 4b. The figures are to show that there can be many different shapes to the terminal surface 4. It can be other shapes than exemplified here, for example hexagonal or irregularly shaped. The same goes for the shape of the first part 4a.

The terminal surface 4 is, for example, circular, and the first part 4a is arranged at the centre of the circular terminal surface 4. A common shape of the terminal surface 4 of a cylindrical secondary cell 1 is circular. If the first part 4a is arranged in the centre of the circular shape, the terminal surface 4 can be made to be rotationally symmetric over the whole surface. It can be beneficial to have a terminal surface 4 that is symmetrical because then there is no need to turn the cell in a specific direction when attaching an external connector to it. The terminal surface 4 may also be designed to have other shapes than circular and the first part 4a is then, preferably, arranged in the centre of that shape so that there is room to attach external connectors around the first part 4a or on the first part 4a.

The first part 4a may have a shape corresponding to the terminal surface 4 shape but it may also have other shapes.

The area of the first part 4a is, for example, between 3% and 20% of the total area of the terminal surface 4, preferably between 6% and 15% of the total area of the terminal surface 4. The first part 4a is large enough for connecting an external interconnection and also small enough to allow the second part 4b to be used for connecting an external interconnection. In case the first part 4a is used for voltage sensor welding with wire-bonding, the area needed is smaller than for example busbar welding with laser on the second part 4b. Busbar welding of often used for automotive use and the high power needed there needs a large area for the current path for the busbar.

The can end side 2a may be a second terminal 5 of opposite polarity than the terminal 3 and the cylindrical secondary cell 1 comprises an isolating part 6 between the can end side 2a and the terminal 3. In other words, the can end side 2a can also act as a second terminal 5. In such a case, the entire can will be electrically connected to the cell electrode that is not electrically connected to the terminal 3. The terminal 3 is electrically insulated from the can 2. In this case, both the positive and the negative terminal is arranged on the same side of the can 2. Thus, both terminals 3, 5 can be connected to external interconnects on the same side. This makes it possible to only make connections on one side of the cell. Thus, a cell is achieved where connections to external loads can all be placed on one side of the cell and where the surface is designed to be suitable for different kinds of attaching methods.

### REFERENCE LIST

1. Cylindrical secondary cell
2. Cylindrical can
a. Can end side
3. Terminal
4. Terminal surface
a. First part
b. Second part
5. Second terminal
6. Isolating part
1. A cylindrical secondary cell (1) comprising:
   a cylindrical can (2) comprising an end side (2a),
   a terminal (3), arranged at the can end side (2a),
wherein the terminal (3) comprises a terminal surface (4) for connecting external electrical interconnects to the cylindrical secondary cell (1), wherein the terminal surface (4) comprises a first part (4a) surrounded by a second part (4b), wherein a first surface roughness of the first part (4a) exceeds a second surface roughness of the second part (4b) by more than a predetermined amount.
2. The cylindrical secondary cell (1) according to embodiment 1, wherein the predetermined amount is 25 μm.
3. The cylindrical secondary cell (1) according to embodiment 1 or 2, wherein the first part (4a) of the terminal surface (4) is knurled.
4. The cylindrical secondary cell (1) according to any preceding embodiment, wherein the second surface roughness is less than 40 μm.
5. The cylindrical secondary cell (1) according to any preceding embodiment, wherein the terminal surface (4) is circular, and the first part (4a) is arranged at the centre of the circular terminal surface (4).
6. The cylindrical secondary cell (1) according to any preceding embodiment, wherein the area of the first part (4a) is between 3% and 20% of the total area of the terminal surface (4), preferably between 6% and 15% of the total area of the terminal surface (4).
7. The cylindrical secondary cell (1) according to any preceding embodiment, wherein the can end side (2a) is a second terminal (5) of opposite polarity than the terminal (3) and the cylindrical secondary cell (1) comprises an isolating part (6) between the can end side (2a) and the terminal (3).

1-7. (canceled)

8. A cylindrical secondary cell comprising:
a cylindrical can comprising an end side, and
a terminal, arranged at the can end side,
wherein:
the terminal comprises a terminal surface for connecting external electrical interconnects to the cylindrical secondary cell,
the terminal surface comprises a first part surrounded by a second part, and
a first surface roughness of the first part exceeds a second surface roughness of the second part by more than a predetermined amount.

9. The cylindrical secondary cell according to claim 8, wherein the predetermined amount is 25 μm.

10. The cylindrical secondary cell according to claim 8, wherein the first part (4a) of the terminal surface is knurled.

11. The cylindrical secondary cell according to claim 8, wherein the second surface roughness is less than 40 μm.

12. The cylindrical secondary cell according to claim 8, wherein the terminal surface is circular, and the first part is arranged at the centre of the circular terminal surface.

13. The cylindrical secondary cell according to claim 8, wherein the area of the first part is between 3% and 20% of the total area of the terminal surface, preferably between 6% and 15% of the total area of the terminal surface.

14. The cylindrical secondary cell according to claim 8, wherein the can end side is a second terminal of opposite polarity than the terminal and the cylindrical secondary cell comprises an isolating part between the can end side and the terminal.
